(19) United States
(12) Patent Application Publication
(10) Pub. No.: US 2026/0098811 A1
(43) Pub. Date: Apr. 9, 2026

(54) Mobile Raman-Spectrometer System and Method for Medical Diagnostics of Human, Animal or Plant Samples

(71) Applicant: NETZSCH-Gerätebau GmbH, Selb (DE)

(72) Inventors: Sabrina Küspert, Selb (DE); Florian Rummel, Selb (DE); Markus Hollering, Wunsiedel (DE); Rebekka Taubmann, Selb (DE)

(21) Appl. No.: 19/351,598

(22) Filed: Oct. 7, 2025

(30) Foreign Application Priority Data
Oct. 9, 2024 (DE) 10 2024 129 205.9

(51) Int. Cl. G01N 21/65

(52) U.S. Cl. CPC G01N 21/65; G01N 2201/0221

(57) ABSTRACT

A mobile Raman-Spectrometer-System for medical diagnosis of human, animal, or plant samples. Such a system includes a measurement device, an evaluation unit connected thereto, having an evaluation program, and, connected thereto, an output unit. The evaluation unit and evaluation program are configured to classify the measured Raman-Spectrometer-Parameters of a human, animal, or plant sample with respect to at least one medical diagnosis, so that a detailed view of the sample can be provided to a user of the mobile Raman-Spectrometer-System by means of the output unit. In addition, a corresponding method is introduced.

### TECHNICAL FIELD

The present invention relates to a mobile Raman-Spectrometer-System as well as a method for medical diagnosis of human, animal, or plant samples.

### BACKGROUND

To be able to generate far-reaching findings concerning human, animal, or plant samples, such samples are frequently extracted from the organism and submitted to complex laboratory analysis. A common alternative is to analyze a fluid that is related to the tissue or organism that is to be studied.

Thus, for instance, samples are extracted from a human being during a biopsy or a surgical procedure by medical specialists and are then turned over to pathologists. In the pathology work, a histological investigation often follows, typically with the staining of tissue and subsequent pathological diagnosis. Tissue samples can also be prepared by tissue sectioning for purposes of further analysis of these individual sections.

Procedures of this kind employing various applications of such techniques can entail a certain time commitment. In addition, in transporting samples a certain logistical infrastructure is required in order to avoid impairments to samples which are often sensitive during this time. In this context, modifications of samples are likely to occur despite all precautions and cannot be entirely ruled out. Biological sample material is generally modified fairly rapidly, and thus subsequent investigations and/or analysis becomes difficult.

In the aforementioned cases of biopsy and extraction during surgery, the necessary medical infrastructure is often available only with maximal providers. Supply and diagnosis in remote locations, such as at high elevations or at sea, can accordingly prove difficult, since the necessary medical infrastructure is either only available with difficulty or not present at all.

Risks may also be incurred if a surgeon decides, only by eye in connection with the existing findings, where to make an incision to remove tumor tissue and/or an entire tumor. If the tumor tissue is contacted through the incision, the tumor is more likely to become dispersed through the body, since the cancerous cells can now migrate more easily and thus cause further injury to the body. A similar situation is found with suspected skin cancer. Here too, at present, samples are extracted and then sent on for laboratory analysis.

Existing imaging methods frequently require more sizable apparatuses, which can be employed only in a special environment, for instance in an application site configured for such purposes. In addition, it is usually not immediately possible to perform the actual surgical intervention at the same time, since such parallel procedures may not be feasible, either for reasons of security or merely because of insufficient space.

### SUMMARY

Against this background, the present invention is based on the object to providing a system and a method that, at least in part, overcomes the aforementioned problems and disadvantages.

This object is fulfilled by means of a mobile Raman-Spectrometer-System having characteristics, as well as by a method having characteristics, notably identified in the patent claims.

A mobile Raman-Spectrometer-System for medical diagnosis of human, animal, or plant samples is accordingly foreseen. Such a Raman-Spectrometer-System in this case comprises a measurement device, to which is connected an evaluation unit having an evaluation program, and attached thereto, an output unit. The evaluation unit and evaluation program are configured here to classify the measured Raman-Spectrometer-Parameters of a human, animal, or plant sample with respect to at least one medical diagnosis, so that a detailed view of the sample can be provided to the user of the mobile Raman-Spectrometer-System by means of the output unit.

In addition, a method for medical diagnosis of human, animal, or plant samples is foreseen. Such a method comprises the following steps: providing and activating an inventive mobile Raman-Spectrometer-System; measurement of a human, animal, or plant sample by means of the inventive mobile Raman-Spectrometer-System; classification of the results of the Raman-spectrometer measurements with respect to at least one medical diagnosis by means of the inventive mobile Raman-Spectrometer-System; output of the classified results by means of the inventive mobile Raman-Spectrometer-System so that a detailed view of the sample can be provided to a user of the inventive mobile Raman-Spectrometer-System by means of the inventive mobile Raman-Spectrometer-System.

One idea underlying the invention consists in the use of Raman spectroscopy for medical diagnosis of human, animal, or plant samples. It is also foreseen here that such a use, parallel to an actual treatment of the sample, can be undertaken if it is desired and seems necessary. Raman spectroscopy makes use of the reciprocal action of light and material. Consequently, insights into the molecular structure and properties of a material become possible, such as in the form of human tissue,

It is thus foreseen to make use of this principle of Raman spectroscopy in order, for example during a surgical intervention performed with the assistance of the inventive system, to allow distinction to be made between healthy and diseased tissue. Instead of a complex removal of a sample and subsequently a time-intensive transport to a laboratory for analysis, which can sometimes be quite distant from the actual sample removal location, diagnosis becomes possible close by thanks to the use of the inventive mobile Raman-Spectrometer-System. Therefore, the procedure can take place directly on site by specialists, with the help of the inventive system, so that immediately during the examination of the sample itself, further-reaching information can be made available concerning circumstances of the sample in real time.

Thus, it is possible to use the mobile Raman-Spectrometer-System both inside an operating room as well as outside. Contrary to imaging methods, which require a considerable amount of space for the various components of the appliance, the inventive system affords the possibility of a mobile application. In other words, the inventive system is configured in such compact form that mobile use is also possible outside of a specialized environment, for example in the form of a maximal provider or a hospital-like facility.

Thanks to the mobile applicability of the inventive system, it becomes possible to dispense with the otherwise required time commitment for complex transports to laboratories, so that the benefits of the diagnosis in the immediate vicinity are available to specialized personnel. In addition, the inventive system requires no separate marking of the sample. With Raman spectroscopy, no marking of samples, such as in the form of cells or cell tissue, is required, contrary to such requirements with other spectroscopic methods.

The inventive system can be applied directly to the organism, which can be of human, animal, or plant nature, so that an incision, in the form of a rapid incision that would be required for the ensuing histology during a surgical intervention or generally during a sample extraction, can be dispensed with. Thus, thanks to the inventive system and/or the related method, there exists the advantage that a surgeon, or other persons in general who are occupied with a sample that is to be examined, has the possibility of making incisions only into healthy tissue or generally into portions of samples considered inconspicuous and, on the basis of a completed classification, healthy and not damaged.

It becomes possible and advantageous, thanks to the present invention, for a surgeon to make incisions only into healthy tissue and, in this manner, to remove a tumor completely without thereby injuring healthy tissue. To this extent the present invention can contribute toward reducing the risk that the tumor can spread further as a result of incisions into tumorous tissue. Degradation of an illness can thus be avoided further, particularly the risk of additional dispersion of tumor cells because of undesired incisions into tumorous tissue. This can occur in parallel with measurement, since the classified measurement results are available to the surgeon in real time during the intervention.

The present invention can also be applied advantageously during an examination that appears to be necessary based merely on a suspected diagnosis. Previously it was necessary to remove and send off a tissue sample for this purpose. With the inventive system it is possible for the specialist physician, even at a patient's first visit, to exclude a possible illness or, in the event of an illness, to introduce necessary treatment steps immediately. This can accelerate treatment decisively and thus constitutes a decisive advantage in terms of time, allowing a chance of survival in case of rapidly advancing conditions.

The sample can take the form of tissue, in which case it can be of human, animal, or plant origin. It can also be related in any other way with this tissue or organism.

The inventive mobile Raman-Spectrometer-System, in this respect, can also be used advantageously outside an operating room, for example in order to perform measurements on the skin of an organism or on the skin tissue of an organism or on another tissue of an organism.

For example, the mobile Raman-Spectrometer-System can advantageously be configured to be used by dermatologists, because of its portable size, for suspected skin cancer, or it can be effective more generally with patients needing possible follow-up or monitoring of their health status. At the same time, the inventive mobile Raman-Spectrometer-System can also be used as part of the equipment of operating rooms.

The inventive mobile Raman-Spectrometer-System likewise can advantageously be applied and used in toxicology and pharmacology. In addition, the inventive mobile Raman-Spectrometer-System is useful in investigations of material composition, for example to confirm differences. This is an advantageous application in assessment or investigation of implants or the like.

One embodiment of the mobile Raman-Spectrometer-System foresees that the evaluation unit with evaluation program can either be combined with at least one database for medical diagnosis of human, animal, or plant samples on the basis of the Raman-Spectrometer-Parameters or at least includes one such database.

In this manner it is possible to provide an especially flexible system that, in addition, offers the possibility of achieving a still more comprehensive classification beyond the data stored in the evaluation unit. Another result is the possibility to access external databases or those that are directly included in the inventive system.

In other words, the inventive system can comprise at least one database or can be linked with a database that allows specialist personnel, directly during or after measurement, to make an evaluation and a related diagnosis. This makes application possible in real time as well.

Another refinement of the mobile Raman-Spectrometer-Systems foresees that the evaluation program can be adjusted by means of at least one user-defined input, so that individualized use of the respective database, becomes possible.

By these means a still more focused application of the inventive system can advantageously be assured. The input can be used advantageously, so that the various linked databases or even just one database can be employed for the desired diagnosis in the best possible way.

A refinement of the mobile Raman-Spectrometer-System foresees that the at least one user-defined input is selected from the following: gender-sensitive input, nourishment data concerning human or animal subjects, medication intake by a human or animal subject, fertilizer application to plant subjects, plant protection application to plant subjects or the like, at least one data element about correlated influences of medications and pathological modifications in at least one organism, suspected diagnoses, at least one data element from a patient register from at least one country, at least one data element about a previous illness of the organism being studied.

Depending on the selection, the aforementioned more specialized application of the inventive system can take even more useful form. In addition, it is possible to provide more focused support of a medical research project or of research on plant organisms. For example, the system can advantageously be configured so that it makes basically gender-sensitive evaluations and in this way, particularly, can support medical research or research on plant organisms that has to take gender-specific differences into account.

The at least one indication on correlating influences of medications and pathological modifications in at least one organism can be present, in particular, as a recognition such as has occurred in India between the use of Diclofenac in livestock and the death of vultures. Because Diclofenac was administered to livestock, this drug was absorbed into the water supply and thus into the various organisms of the local vulture population, leading to liquidation of vultures, for which the medication was fatal.

Thus, it is possible that an input provides a specific database with additional or supplemental data, such as on a patient's nourishment or medication, and thus correlating methods or corrections can be made advantageously, for instance in order to correct influences from factors that do not necessarily or exclusively accompany an illness that is to be diagnosed.

In this respect it is conceivable that even some initial data concerning the aforementioned circumstances are present in the particular databank, and the further inputs, for example also as user-defined adaptation of the database, can advantageously be adopted in real time, in the manner of an updating with the most recent data.

One embodiment of the mobile Raman-Spectrometer-System foresees that the measurement device is configured to measure Raman-Spectrometer-Parameters of the human, animal, or plant samples separately or on the organism.

Flexible use of the mobile Raman-Spectrometer-System can thus advantageously be assured. In particular, direct contact with the organism can support some of the aforementioned advantages even better. Thus, it can be arranged that the corresponding components of the mobile Raman-Spectrometer-System can be applied directly on the sample, such as in the form of tissue that is to be examined, or alternatively these components, such as the measurement device, can be held near the sample.

In particular, advantageously, a medical specialist can apply the corresponding components of the mobile Raman-Spectrometer-System, such as the measurement device, directly onto the sample to be measured, such as in the form of cell tissue or tissue more generally, or else such a specialist can hold the corresponding components of the mobile Raman-Spectrometer-System directly in front of the tissue that is to be measured and/or examined, without the need for a surgical intervention.

This can thus occur in real time and/or instantly on the tissue or else on the organism that is to be studied. Investigation with the inventive system thus proceeds immediately, in terms of time and place. In other words, the present inventive system is configured for use directly on the organism to be examined and/or on partial areas of the organism that is to be examined.

Thus, in particular, components such as the measurement device can be used not only in the tissue but also on the tissue and therefore before extraction of the tissue or material sample. Thus, the tissue to be examined remains intact and, at most, is only removed when such a step can be considered necessary on the basis of a diagnosis made by means of the system or at least with support from the system.

One embodiment of the mobile Raman-Spectrometer-System foresees the inclusion of an energy system that is configured for autarkic energy supply or for reliance on an external electrical energy supply network.

Autarkic energy supply with a rechargeable, independent energy system supports the portable functioning of the inventive system in advantageous way. Mobile use of the inventive Raman-Spectrometer-System can thus become even more secure. For example, an organism that is to be investigated can thus be examined in advantageous manner, rapidly and efficiently, even outside an operating room, in order to allow completion of a coherent diagnosis in real time and in the immediate vicinity.

Since network operation is also feasible, the inventive system thus makes it possible for the system to be part of a more extensive infrastructure environment such as an operating room, since a central energy supply apparatus can be made available and can function to ensure trouble-free performance.

In other words, the inventive system can be employed in both network and battery-driven operation, allowing it to function both in a stationary operating mode as well as in mobile mode. In mobile operating mode, in particular, the system is suitable for advantageous use and/or operation even in distant locations lacking major infrastructure.

A refinement of the mobile Raman-Spectrometer-System foresees that the Raman-Spectrometer-System basically consists of outer materials including stainless steel, which are suitable for a sterilization process, so that the Raman-Spectrometer-System can be employed in an operating room after completion of a sterilization process.

To this extent, the present system can be advantageously used wherever a hygienically flawless environment can be maintained stringently. Accordingly, the system can be hygienically designed and configured. In particular, this advantage can be most effectively assured by employing an at least partial housing with suitable materials, such as stainless steel or the like.

Another embodiment of the mobile Raman-Spectrometer-System foresees that the mobile Raman-Spectrometer-System is configured in order to measure and to classify a number of samples simultaneously.

Accordingly, an especially efficient use of the inventive system is possible. For example, neighboring tissue areas on an organism that is to be examined can be advantageously measured and/or individual critical areas can be measured.

Another embodiment of the mobile Raman-Spectrometer-System foresees that the inventive system is configured to be controlled by at least one external device that can be coupled with the Raman-Spectrometer-System.

An especially flexible-use system can be provided for application in more remote regions in particular. Even medical staff who do not master all modes of operation of an elaborately configured operating room can thus immediately perform an application of the system using simple means, with advantageous results. The various external devices for this purpose can comprise a separate application, for example, which can be provided by the system.

It is also conceivable that the evaluation unit with its evaluation program is configured to be reflected on the external device, so that an immediate control and operation mode of the inventive mobile Raman-Spectrometer-System is possible by means of the evaluation unit with its evaluation program via the particular external device.

One embodiment of the mobile Raman-Spectrometer-System provides that the external device can comprise a choice of the following: smartphone, tablet, smartwatch, laptop, cloud application. The aforementioned advantages thus can thus be obtained in more deliberate and user-friendly ways.

An embodiment of the mobile Raman-Spectrometer-System foresees that the measurement device comprises further connecting means for coupling the measurement device with the evaluation unit and its evaluation program, wherein such means are configured to employ the measurement device separately from the other components of the mobile Raman-Spectrometer-System in the vicinity of the mobile Raman-Spectrometer-System at a distance of 0.1 to 10 meters, preferably of 0.5 to 5 m, or even of 1 to 3 m, so that the Raman-Spectrometer-Parameters of a human, animal, or plant sample (measured by the measurement device) can correspondingly be obtained from a choice of locations in relation to the other components of the mobile Raman-Spectrometer-System.

Flexible application can be still further assured. In particular, less accessible components of organisms that are to be examined can thus be examined advantageously, because the measurement device can be optimally placed separately on the inaccessible location, so that measurements can be performed not only more easily but also, in particular, with deliberate precision.

Another embodiment of the mobile Raman-Spectrometer-System foresees that the measurement device is basically rod-like in shape and has a volume that can be grasped with one hand, so that a first end portion is configured to be brought into contact with the sample to be measured and a second end portion is configured to hold at least one illumination source located replaceably inside the measurement device so that emitted beams from the at least one illumination source can be diverted in the direction of the first end portion.

The inventive system is thus particularly user-friendly and operator-friendly in operation. The rod-shaped configuration of the measurement device can be configured to be of the size of a pen, pencil, or the like, so that it can be applied directly on the tissue or else on bodily fluids containing, for example, dispersed or dissolved particles or droplets or bubbles or particles. It can likewise be used on materials situated inside the body of the organism but potentially alien to the body. A surgeon can therefore deploy this measurement device like a kind of probe having the size of a pen, pencil, or the like.

One embodiment of the inventive method foresees the following additional method steps: connection of the evaluation unit and evaluation program of the mobile Raman-Spectrometer-System with at least one database for medical diagnosis of human, animal, or plant samples on the basis of the Raman-Spectrometer-Parameters; adjustment of the evaluation program by means of at least one user-defined input, so that an individualized usage of the connected external database is possible.

In this matter it is possible to provide a particularly flexible method, which in addition offers the possibility of making an even more extensive classification beyond the data stored in the evaluation unit. Thus, it can become possible to have access to external databases or to call up databases that are a direct part of the inventive system.

In other words, the inventive method can provide that the inventive system it aims to use contains at least one database or is linked to a database, thus assuring specialist personnel a means to make an evaluation directly during or after the measurement as well as to perform a related diagnosis. The method can even be applied in real time.

Another embodiment of the inventive method foresees that the at least one user-defined input is selected from the following: gender-sensitive input, nourishment data concerning human or animal subjects, medication intake by a human or animal subject, application of fertilizers on plant subjects, application of plant protection on plant subjects or the like, at least one data element on correlated influences of medication and pathological changes in at least one organism, suspected diagnoses, at least one data element from a patient register of at least one country, at least one data element concerning a prior illness of the organism that is to be examined.

Depending on the selection, the aforementioned specialized application of the inventive method can be configured even more effectively. More focused support of a medical research effort or of research on plant organisms is also assured. For example, the method can advantageously be configured so that it fundamentally makes gender-sensitive evaluations and in this manner, in particular, supports medical research efforts or research on plan organisms that need to take gender-specific differences into account.

Thus, it becomes possible that a particular database can be provided with additional data, such as concerning nourishment or medication of a patient, so that correlating methods or corrections can accordingly be performed, for example to correct influences of factors that are not necessarily or exclusively associated with an ailment that is to be diagnosed. Correlating methods, for example, can be useful in cases where certain influences, such as hormonal fluctuations in a woman's cycle, need to be clarified, considered, or taken into account.

In this context, it is conceivable that initial data concerning aforementioned circumstances are already available in the particular database and the additional inputs, for example, can also be performed advantageously in real time also as user-defined adaptation of the database in the sense of updating with the most recent data.

The at least one data element concerning correlating influences of medications and pathological modifications in at least one organism can, for example, be present in the sense of a recognition, such as occurred in India between the use of Diclofenac in livestock and the mortality of vultures. Because of the application of Diclofenac to livestock, this medication entered through the drinking water into the respective organisms of the local vulture population, leading to the death of vultures, since vultures have no tolerance for this medication.

### BRIEF DESCRIPTION OF THE DRAWINGS

The invention is hereinafter explained with reference to the drawings, which are as follows:

FIG. 1 shows a schematic depiction of a mobile Raman-Spectrometer-System according to an embodiment of the present invention;

FIG. 2 shows a schematic depiction of an application scenario of a mobile Raman-Spectrometer-System according to an embodiment of the present invention;

FIG. 3 shows a schematic depiction of an additional application scenario of a mobile Raman-Spectrometer-System according to an embodiment of the present invention;

FIG. 4 shows a schematic flow diagram for a method for medical diagnosis of human, animal, or plant samples according to an embodiment of the present invention.

The same reference numbers in the drawings designate the same or functionally similar components, unless otherwise indicated.

### DETAILED DESCRIPTION

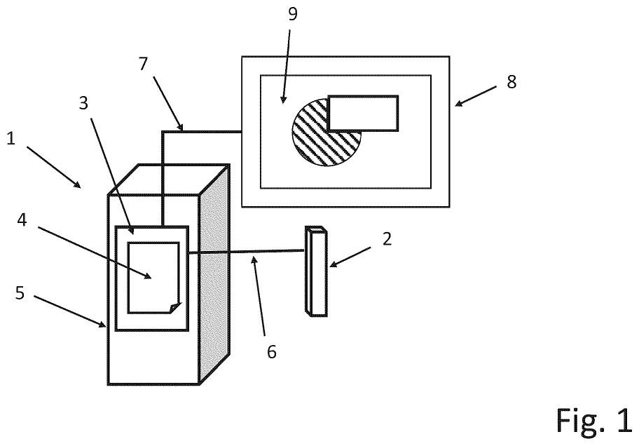

FIG. 1 shows a schematic depiction of a mobile Raman-Spectrometer-System 1 according to an embodiment of the present invention. Here the mobile Raman-Spectrometer-System 1 is intended for mobile use. In particular it is conceivable that all dimensions of individual components of the depicted mobile Raman-Spectrometer-System 1 are determined so that simple transport becomes possible, for example by a person or a drone alone.

For example, the dimensions can be determined in such a way that a mobile Raman-Spectrometer-System 1 results in a structure resembling that of a handheld device, which can be provided and/or deployed in mobile or stationary manner in an operating room or on the part of a specialist in the art.

To this extent it is conceivable, in a number of possible embodiment applications of the inventive mobile Raman-Spectrometer-System 1, that the said system 1 is at least partly configured to be portable.

The mobile Raman-Spectrometer-System 1 can also be considered and accordingly designated as a medical device which can advantageously be applied in a medical context, for example in medical diagnosis of human, animal, or plant samples.

Optionally the mobile Raman-Spectrometer-System 1 can be equipped with a surgical tool in order to control as precisely as possible the spatial distance between tissue that is to be investigated/cut open/removed and the tissue examined by the measurement. Optionally, the mobile Raman-Spectrometer-System 1 can also be equipped with a marking unit in order to mark the tissue that is to be removed, for example on the skin or the particular organ.

In addition, the mobile Raman-Spectrometer-System 1 is depicted having a measurement device 2 and, connected thereto, an evaluation unit 3 with evaluation program 4. Accordingly, in FIG. 1 the evaluation unit 3 and evaluation program 4 form an integral component of a main body 5 of the mobile Raman-Spectrometer-System 1. In addition, these components can be configured to be placed in flexibly replaceable manner in this main body 5. Operating modules of the evaluation unit 3 with its evaluation program 4, in addition, in an embodiment variant (not presented in detail), can be provided, in user-friendly manner, in recesses of the main body 5 that are foreseen for this purpose. Moreover, in an embodiment variant (not presented in detail), such operating modules can be provided separately and essentially placed on one outer side of the main body 5.

The main body 5, as shown, can have an essentially rectangular external shape. Any other forms are conceivable. It can also be foreseen that the main body 5, in an embodiment variant not presented in detail, is configured in multiple parts, so that the said main body 5 can easily be disassembled, such as for transport or cleaning purposes.

For example, the main body 5 can be configured as partially or completely of stainless-steel construction. Other materials are possible, although it is advantageous if such materials are cleansable by means of a commonly known sterilization process. It is advantageous, for example, if the materials are of such a nature that they can be cleansed in an autoclave or similar process and thus can protect interior components of the system 1 from external impacts.

The measurement device 2 is shown as coupled with the evaluation unit 3 and its evaluation program 4 by means of a first connecting cable 6. Alternatively, it is foreseeable for the measurement device 2 to be coupled with the evaluation unit 3 and its evaluation program 4 by means of an optional radio connection.

In an embodiment variant (not shown in detail), in addition, it is foreseen that the measurement device 2 and main body 5, together with the components of the system 1 situated inside the main body 5, form a constructive unit and thereby are essentially either partially or totally rod-like in shape

Another feature of the invention is that the dimensions of the device allow a user to grasp the system 1 comfortably with one hand, as easily as holding a pen or pencil, during an examination. The dimensions also make it possible to use a suitable holder device rather than a human hand for grasping the system.

The measurement device 2 shown in FIG. 1 is rod-like in shape and thus can be configured so that it is comfortable to use with a single hand. In this connection, the essentially rod-shaped measurement device 2, sized for grasping by one hand, can comprise a first end portion, capable of being put in contact with the sample that is to be examined, while a second end portion is configured so that it can hold at least one illumination source (not shown in detail), for example a laser apparatus or the like, replaceably located inside the measurement device 2, so that emitted beams from the at least one illumination source can be guided essentially in the direction of the first end portion.

In another embodiment variant (not illustrated in detail), the measurement device 2 can comprise further connecting means, which are configured to couple the measurement device 2 with the evaluation unit 3 and evaluation program 4 in such a way that the measurement device 2 can be employed separately from the other components of the mobile Raman-Spectrometer-System 1 in proximity to the mobile Raman-Spectrometer-System 1 at a distance of 0.1 to 10 meters, preferably of 0.5 to 5 m, or even of 1 to 3 m, so that the Raman-Spectrometer-Parameters of a human, animal, or plant sample, measured by means of the measurement device 2, can be obtained from a choice of locations in relation to the other components of the mobile Raman-Spectrometer-System 1.

An output unit 8 of the mobile Raman-Spectrometer-System 1 is depicted above the main body 5, with respect to the image plane, and is coupled with the evaluation unit 4 and its evaluation program 5 by a second connecting cable 7. This output unit 8 of the mobile Raman-Spectrometer-System 1 can, for example, take the form of a regular commercial monitoring system or the like. In addition, a monitoring system can be applied as it usually is used in an operating room. Likewise, a transmission unit can be provided as an option, which forwards the current images, for instance in real time, to an additional medical specialist, for example a pathologist, so that this person is not required to be directly present but rather can even be located, for example, in a different country. Global experts specialized in medical disciplines can thus advantageously be linked together in order to achieve the best possible outcomes. Thus, in addition, the need for such medical specialists to travel can be further reduced.

Two different geometric forms, for example, are depicted on an image surface 9 of the output unit 8 of the mobile Raman-Spectrometer-System 1, such that it is conceivable that the rectangular shape, for instance, contains diseased tissue of a sample that is to be measured (and is not illustrated in detail) and the circular-shaped tissue, for instance, accordingly comprises healthy tissue of a sample that is to be measured (and is not shown in detail). The output unit 8 can also optionally be foreseen as a smaller monitoring unit, which can be positioned accordingly on the measurement device 2. Thus, a user can oversee all important actions within a single field of vision, particularly during critical actions, without any need for a field of vision to be modified, such as by head motions or head turnings, especially during critical actions.

The illustrated evaluation unit 3 with its evaluation program 4 is configured, to this extent, to classify the measured Raman-Spectrometer-Parameters of a human, animal, or plant sample (not illustrated in detail) with respect to at least one medical diagnosis, so that a detailed view of the sample can be provided to a user of the mobile Raman-Spectrometer-System 1 by means of the output unit 8. The detailed view here can also be presented by means of the output unit 8 in such a way that markings can be foreseen on the output unit 8 in order to delimit a diagnosed area and, if required, to highlight various diagnosed areas further.

The mobile Raman-Spectrometer-System 1, in an embodiment variation that is not illustrated in detail, can optionally be configured to treat and/or to measure a number of samples that are to be evaluated simultaneously in order, for example, to improve the statistical value of the examination.

For such purposes, two measurement devices 2, for example, can also be provided or there can be one measurement device 2 of the mobile Raman-Spectrometer-System 1 that is configured to measure neighboring regions on the tissue or to measure two separate samples of different organisms simultaneously, while they are placed at a certain minimum distance from one another.

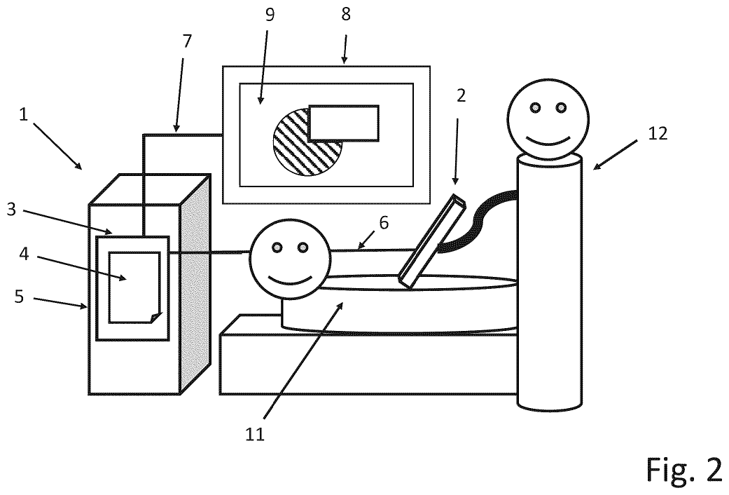

FIG. 2 shows a schematic depiction of a user scenario of a mobile Raman-Spectrometer-System 1 according to an embodiment of the present invention. It can take the form, for instance, of a mobile Raman-Spectrometer-System 1, according to the one shown in FIG. 1. Other options include the aforementioned embodiment variants (not illustrated in detail) of the mobile Raman-Spectrometer-System 1 shown accordingly in FIG. 2.

A patient 11 lying on a treatment table 10 is being examined by a medical specialist 12 standing beside the table. Here the medical specialist 12 holds a rod-shaped measurement device 2 of the mobile Raman-Spectrometer-System 1 directly on a tissue area of the body of the patient 11.

This case could involve, for example, a tissue area of a portion of skin close to the abdomen of the patient 11. However, it is also possible to foresee examinations of other tissue areas of the patient 11. Thus, for example, this could be a partially interior examination of tissue areas, such as the mucous membrane of the oral cavity or the like.

The measured Raman-Spectrometer-Parameters are transmitted via a first connecting cable 6 to an evaluation unit 4 with its evaluation program 5 of the mobile Raman-Spectrometer-System 1. The evaluation unit 3 with its evaluation program 4 is configured here to classify the measured Raman-Spectrometer-Parameters of the human sample in this case, with respect to at least one medical diagnosis, so that a detailed view of the sample can be provided to the medical specialist 12, that is, the user of the mobile Raman-Spectrometer-System 1, by means of an output unit 8.

During the measurement, thus, the medical specialist 12 can review the examined sample in a classified view on an image surface 9 of the output unit 8 and then can decide whether and where the tissue, for instance, must be removed surgically or by sectioning technology.

In this connection it is conceivable that the illustrated mobile Raman-Spectrometer-System 1 is configured so that the evaluation unit 3 and its evaluation program 4 can be combined with at least one database (not illustrated in detail) for medical diagnosis of human, animal, or plant samples for the purposes of classification, on the basis of the Raman-Spectrometer-Parameters.

It is also conceivable for this database to be an integral component of the mobile Raman-Spectrometer-System 1. Another possibility is that several databases can be coupled simultaneously or as required. Several databases of various mobile Raman-Spectrometer-Systems 1 may also be coupled for various classification purposes in a particular mobile Raman-Spectrometer-System 1, so that a still more secure and efficient classification can be obtained by means of these networked databases.

It is also possible that the evaluation program 4 can be adjusted by means of at least one user-defined input, so that an individualized usage of the respective coupled database can result. This at least one user-defined input can be selected from the following: gender-sensitive input, nourishment data concerning human or animal subjects, medication intake by a human or animal subject, fertilizer application to plant subjects, plant protection application to plant subjects.

Such an input can also be made as an updating procedure of the respective coupled database. It is also conceivable that such a process can be performed at least partly in such a way that such an updating, for example, can be made in the background, so that a user-defined input and thus an authorization of such inputs is conceivable.

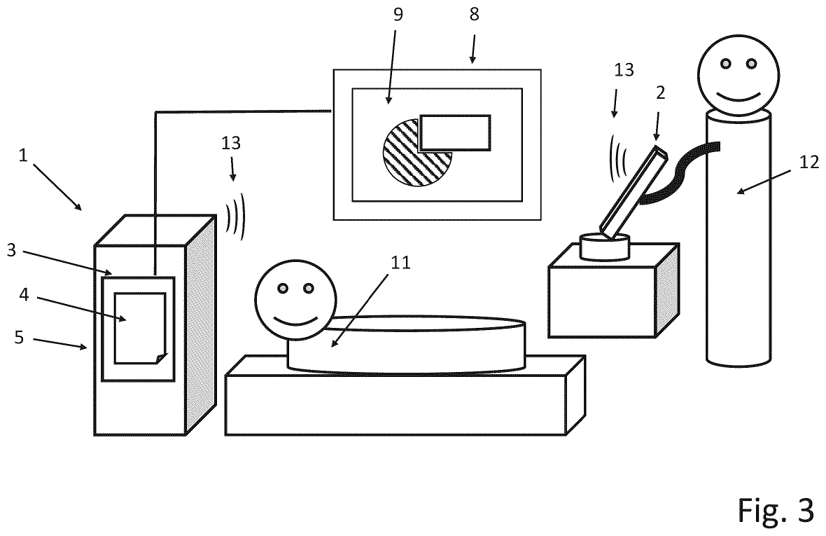

FIG. 3 shows a schematic depiction of an additional application scenario of a mobile Raman-Spectrometer-System 1 according to an embodiment of the present invention. It can take the form of a mobile Raman-Spectrometer-System 1 according to the one depicted in FIG. 1. Further possibilities include the aforementioned embodiment variants of the mobile Raman-Spectrometer-System 1 (not illustrated in detail) corresponding to FIG. 3.

This user scenario depicts a medical specialist 12, standing at a distance from a supine patient 11 who is to be examined, so that this medical specialist 12 holds by hand a measurement device 2 of a mobile Raman-Spectrometer-System 1 to allow closer measurement and/or examination of a sample previously extracted from the patient 11.

The measurement device 2 of a mobile Raman-Spectrometer-System 1 here comprises additional connecting means (not shown in detail) for coupling the measurement device 2 with an evaluation unit 3 and its evaluation program 4 of the mobile Raman-Spectrometer-System 1, which are configured to employ the measurement device 2 separately from the other components of the mobile Raman-Spectrometer-System 1 in the vicinity of the mobile Raman-Spectrometer-System 1 at a distance of 0.1 to 10 meters, preferably of 0.5 to 5 m, or even of 1 to 3 m, so that the Raman-Spectrometer-Parameters of (in this case) the human sample, measured by means of the measurement device 2, can be obtained from a choice of locations in relation to the other components of the mobile Raman-Spectrometer-System 1.

Various radio wave symbols 13 in FIG. 3 constitute this coupling between the measurement device 2 and the evaluation unit 3 with its evaluation program 4.

To this extent it can be foreseen that the additional connecting means (not illustrated in detail) are configured in such a way that various sender/receiver modules are arranged on both sides so that this radio connection can be provided accurately at a distance of 0.1 to 10 meters, preferably of 0.5 to 5 m, or even of 1 to 3 m. For example, the additional connecting means can include any available radio connecting technologies for a transmission of obtained measurement data.

Thus, the illustrated measurement device 2 is configured to measure Raman-Spectrometer-Parameters of the human sample (in this case) separately or on the organism, so that a separate measurement is taken in the near vicinity in this case.

In an embodiment variant (not shown in detail) it can be understood that the Raman-Spectrometer-System 1 is configured to measure and classify a number of samples simultaneously.

The illustrated measurement device 2 is essentially rod-shaped in configuration and comprises a volume that can be grasped by one hand, so that a first end portion is configured so as to be brought into contact with the sample that is to be measured, and a second end portion is configured to hold at least one illuminating source located replaceably inside the measurement device 2, so that emitted beams of the at least one illuminating source can be guided essentially in the direction of the first end portion.

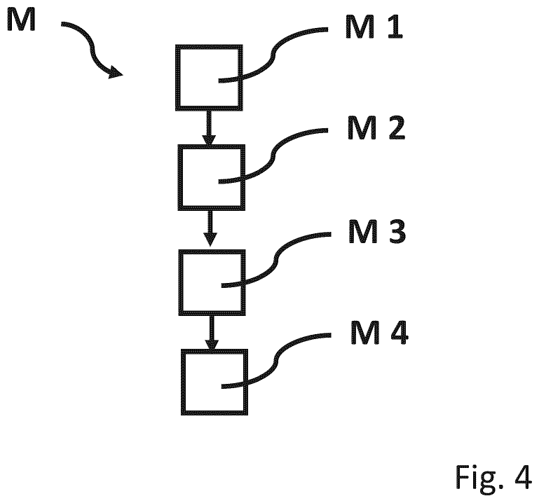

FIG. 4 shows a schematic flow diagram of a method for medical diagnosis of human, animal, or plant samples according to an embodiment example of the present invention. In a first method step M1, an inventive mobile Raman-Spectrometer-System 1 is provided and activated. In a second step M2 of the method, a human, animal, or plant sample is measured by means of the mobile Raman-Spectrometer-System 1. In a third step M3 of the method, results of the Raman-spectrometer measurements are classified with respect to at least one medical diagnosis by means of the mobile Raman-Spectrometer-System 1. In a fourth step M4 of the method, the classified results are output by means of the mobile Raman-Spectrometer-System 1, so that a detailed view of the sample can be provided to a user of the mobile Raman-Spectrometer-System 1 by means of the mobile Raman-Spectrometer-System 1.

1. A mobile Raman-Spectrometer-System for medical diagnosis of human, animal, or plant samples comprising a measurement device, an evaluation unit connected thereto, having an evaluation program, and, connected thereto, an output unit, wherein the evaluation unit and evaluation program are configured to classify the measured Raman-Spectrometer-Parameters of a human, animal, or plant sample with respect to at least one medical diagnosis, so that a detailed view of the sample can be provided to a user of the mobile Raman-Spectrometer-System by means of the output unit

2. The mobile Raman-Spectrometer-System according to claim 1, wherein the evaluation unit and evaluation program for the purposes of classification can be connected with at least one database for medical diagnosis of human, animal, or plant samples on the basis of the Raman-Spectrometer-Parameters, or at least include such a database.

3. The mobile Raman-Spectrometer-System according to claim 2, wherein the evaluation program can be adjusted by means of at least one user-defined input, so that an individualized use of the respective database is possible.

4. The mobile Raman-Spectrometer-System according to claim 3, wherein the at least one user-defined input is selected from the following: gender-sensitive input, nourishment data concerning human or animal subjects, medication intake by a human or animal subject, fertilizer application to plant subjects, plant protection application to plant subjects, or the like, at least one data element concerning correlating influences of medications and pathological modifications in at least one organism, suspected diagnoses, at least one data element from a patient register from at least one country, at least one data element concerning an illness of the organism that is to be examined.

5. The mobile Raman-Spectrometer-System according to claim 1, wherein the measurement device is configured to measure Raman-Spectrometer-Parameters of the human, animal, or plant samples separately or on the organism.

6. The mobile Raman-Spectrometer-System according to claim 1, wherein the mobile Raman-Spectrometer-System comprises an energy system which is configured to supply the mobile Raman-Spectrometer-System with electrical energy autarkically or by means of an external energy supply network.

7. The mobile Raman-Spectrometer-System according to claim 1, wherein the mobile Raman-Spectrometer-System is composed essentially of external materials, in particular stainless steel, which are suited for a sterilization method, so that the mobile Raman-Spectrometer-System can be used in an operating room after completion of a sterilization process.

8. The mobile Raman-Spectrometer-System according to claim 1, wherein the mobile Raman-Spectrometer-System is configured to measure and to classify a number of samples simultaneously.

9. The mobile Raman-Spectrometer-System according to claim 1, wherein the mobile Raman-Spectrometer-System is configured to be controlled by means of at least one external apparatus that can be coupled with the mobile Raman-Spectrometer-System.

10. The mobile Raman-Spectrometer-System according to claim 9, wherein the external apparatus can be selected from the following: smartphone, tablet, smartwatch, laptop, or Cloud application.

11. The mobile Raman-Spectrometer-System according to claim 1, wherein the measurement device comprises further connecting means for coupling the measurement system with the evaluation unit and evaluation program, which are configured to employ the measurement device separately from the other components of the mobile Raman-Spectrometer-System in the vicinity of the mobile Raman-Spectrometer-System at a distance of 0.1 to 10 meters, preferably of 0.5 to 5 m, or even of 1 to 3 m, so that the Raman-Spectrometer-Parameters of a human, animal, or plant sample, measured by means of the measurement device, correspondingly can be obtained from a choice of locations in relation to the other components of the mobile Raman-Spectrometer-System.

12. The mobile Raman-Spectrometer-System according to claim 1, wherein the measurement device is configured as essentially rod-shaped and has a volume that can be grasped with one hand, so that a first end portion is configured so as to be brought into contact with the sample to be measured, and a second end portion is configured for holding at least one illumination source located removably inside the measurement unit, so that emitted rays of the at least one illumination source can be guided essentially in the direction toward the first end portion.

13. A method for medical diagnosis of human, animal, or plant samples comprising the following steps:
providing and activating a mobile Raman-Spectrometer-System including a measurement device, an evaluation unit connected thereto, having an evaluation program, and, connected thereto, an output unit wherein the evaluation unit and evaluation program are configured to classify the measured Raman-Spectrometer-Parameters of a human, animal, or plant sample with respect to at least one medical diagnosis, so that a detailed view of the sample can be provided to a user;
classification of results of the Raman-spectrometer measurements with respect to at least one medical diagnosis by means of the mobile Raman-Spectrometer-System; and
output of the classified results by means of the mobile Raman-Spectrometer-System, so that a detailed view of the sample can be provided to a user of the mobile Raman-Spectrometer-System by means of the mobile Raman-Spectrometer-System.

14. The method according to claim 10, comprising the following additional steps:
connection of the evaluation unit and evaluation program of the mobile Raman-Spectrometer-System with at least one database for medical diagnosis of human, animal, or plant samples on the basis of the Raman-Spectrometer-Parameters; and
adjustment of the evaluation program by means of at least one user-defined input, so that individualized use of the connected external database is possible.

15. The method according to claim 12, wherein the at least one user-defined input is selected from the following: gender-sensitive input, nourishment data concerning human or animal subjects, medication intake by a human or animal subject, fertilizer application to plant subjects, plant protection application to plant subjects, or the like, at least one data element concerning correlating influences of medications and pathological modifications in at least one organism, suspected diagnoses, at least one data element from a patient register from at least one country, at least one data element concerning a prior illness of the organism that is to be examined.

16. The mobile Raman-Spectrometer-System according to claim 2, wherein the mobile Raman-Spectrometer-System is configured to be controlled by means of at least one external apparatus that can be coupled with the mobile Raman-Spectrometer-System.

17. The mobile Raman-Spectrometer-System according to claim 2, wherein the mobile Raman-Spectrometer-System comprises an energy system which is configured to supply the mobile Raman-Spectrometer-System with electrical energy autarkically or by means of an external energy supply network.

18. The mobile Raman-Spectrometer-System according to claim 2, wherein the mobile Raman-Spectrometer-System is composed essentially of external materials, in particular stainless steel, which are suited for a sterilization method, so that the mobile Raman-Spectrometer-System can be used in an operating room after completion of a sterilization process.

19. The mobile Raman-Spectrometer-System according to claim 2, wherein the mobile Raman-Spectrometer-System is configured to be controlled by means of at least one external apparatus that can be coupled with the mobile Raman-Spectrometer-System.

20. The mobile Raman-Spectrometer-System according to claim 2, wherein the mobile Raman-Spectrometer-System is configured to be controlled by means of at least one external apparatus that can be coupled with the mobile Raman-Spectrometer-System.
